(19) United States
(12) Patent Application Publication
(10) Pub. No.: US 2016/0069487 A1
(43) Pub. Date: Mar. 10, 2016

(54) FLEXIBLE CONDUIT WITH TAPERED MEMBERS

(71) Applicant: International Engine Intellectual Property Company, LLC, Lisle, IL (US)

(72) Inventors: Qin Yang, Wheaton, IL (US); David Aalazar Duarte, Aurora, IL (US); Thomas L. Cumbey, Oswego, IL (US); Edward M. Derybowski, Hanover Park, IL (US)

(21) Appl. No.: 14/480,722

(22) Filed: Sep. 9, 2014

(51) Int. Cl. F16L 11/26; F16L 13/02

(52) U.S. Cl. CPC F16L 11/26; F16L 13/02

(57) ABSTRACT

A flexible conduit system having a corrugated flexible conduit, a first tapered member disposed in the flexible conduit at the inlet end or close to the inlet end of the corrugated flexible conduit and a second tapered member disposed in the flexible conduit at the outlet end or close to the outlet end of the corrugated flexible conduit. The first tapered member at the inlet end converges and centers the flow of gases through the flexible conduit and the second tapered member at the outlet end channels the flow of gases away from the corrugations of the corrugated flexible conduit thereby reducing noise in the flexible conduit system.

### TECHNICAL FIELD

The present disclosures relate generally to the field of conduits.

### BACKGROUND

Flexible pipes or conduits are used in a variety of applications, and have been found to be well suited for providing a relative motion between one component and another. A typical bellows type flexible conduit is flexible due to the presence of corrugations as exemplified in U.S Pat. No. 7,066,495 to Thomas et al. The ‘495 patent is incorporated herein in its entirety.

However, corrugated conduits have been found to create undesirable noise and demonstrate other undesirable attributes as well. There is a desire for flexible conduits having improved performance attributes.

### SUMMARY

Embodiments described herein relate to a flexible conduit as a part of a conduit system that includes a first tapered member with a first inner surface having a first diameter and a second diameter smaller than the first diameter disposed within the flexible conduit. Similarly, a second tapered member with a second inner surface having a third diameter and a fourth diameter smaller than the third diameter is disposed within the flexible conduit, downstream of the first tapered member.

In the embodiments described herein, the first tapered member having an inner surface defined by the first diameter and the second diameter, the inner surface of the first tapered member tapering down from the first diameter to the second diameter to center a gas flowing through the flexible conduit from the inlet end of the flexible conduit away from the corrugated walls of the flexible conduit. The second tapered member, having an inner surface defined by the third diameter and the fourth diameter, the inner surface of the second tapered member tapering down from the third diameter to the fourth diameter to have a diverging effect, is downstream of the first tapered member and directs or channels the gases away from the corrugated walls of the flexible conduit. By keeping the gases away from the corrugated walls of the flexible conduit, noise is reduced. These embodiments can be modified accordingly for flexible conduit systems used in a variety of applications such as automotive, marine and other applications.

### BRIEF DESCRIPTION OF THE DRAWINGS

FIG. 1 is a diagram of an embodiment of a flexible conduit system described herein;

FIG. 2 is a diagram of a second embodiment of a flexible conduit system described herein;

FIG. 3 is a diagram that shows a pattern of the flow of gases through the second embodiment of the flexible conduit system; and

FIG. 4 is a diagram of yet another embodiment of a flexible conduit system described herein.

### DETAILED DESCRIPTION

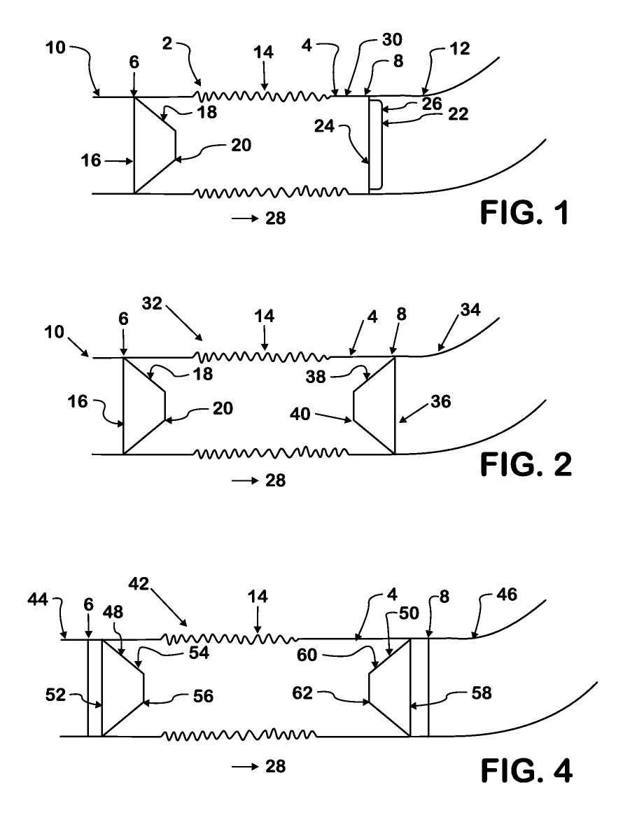

FIG. 1 shows a flexible conduit system 2 with a flexible conduit 4, having an inlet end 6 coupled to an inlet pipe 10, which may, for instance, be part of an aftertreatment system of a vehicle and having an outlet end 8 coupled to an outlet pipe 12, which may, for instance, be part of a cab mounted exhaust pipe of a vehicle. Gases 28 may flow through the inlet pipe 10, the flexible conduit 4 and finally out of the outlet pipe 12 into atmosphere.

The inlet pipe 10 may be coupled to the inlet end 6 and the outlet pipe 12 may be coupled to the outlet end 8 of the flexible conduit 4 by means of welding, brazing or other fastening means to form a connection, or by a flexible or rotary attachment which allows the inlet or outlet pipe to slide or rotate relative to the flexible conduit 4. The flexible conduit 4 comprises of corrugations 14 across a portion or an entire length of the flexible conduit 4. These corrugations 14 enable the flexible conduit 4 to be flexible and elastic. Other means of increasing flexibility of conduits can be used, such as braiding, helical winding, etc. An issue with corrugations, braiding and helical windings is that they form irregularities on an inner surface of the flexible conduit, which creates undesirable levels of noise when gases flow through the flexible conduit past the irregularities. If the gases are hot, the excessive heat may cause an increase in the noise levels through the conduit system as well, since the heat may change the geometry of the flexible conduit through expansion. Smooth liners have been used in the past to cover up the irregularities and provide a smooth continuous inner surface of the flexible conduit, which has been found to reduce the noise when gases pass through the flexible conduit; however the liners are not desirable since they reduce the flexibility of the flexible conduits. In certain applications, such as those with relative motion or space restrictions, such as between a truck chassis and cab, for example, flexibility of the conduits needs to be increased. The embodiments described below are some ways of reducing noise in a flexible conduit without the use of a liner. Other embodiments beyond those described are possible.

A plate 22, with a thickness and external diameter 26 may be fixed onto the internal surface 30 along the outlet end 8 of the flexible conduit 4 or along the length of the outlet pipe 12 such as through the process of welding or any other suitable process. The plate 22 may be made from steel, aluminum or any other suitable metallic, non-metallic or composite material. The plate 22 has an smaller internal diameter hole 24 for centralizing the gases 28 passing through the flexible conduit 4, keeping the gases 28 away from the corrugations 14 and inner surface 30 of the flexible conduit 4. The addition of the plate 22 removes the need for a liner thereby resulting in increased flexibility of the flexible conduit 4. In this embodiment, the inlet pipe 10 coupled to the inlet end 6 of the flexible conduit 4 has a variable cross-section such that the inlet pipe 10 has a converging effect on the gases 28 entering into the flexible conduit 4. The inlet pipe 10, starting with a first diameter 16 at the point of coupling to the flexible conduit 4 comprises of a first inner surface 18 that tapers or slopes down to a second diameter 20 which is smaller than the first diameter 16. The second diameter 20 is determined based on allowed levels of restriction of the gases 28 based on experimentation and noise reduction required for the application. This second diameter 20 creates a converging effect that redirects the gases 28 by centering the gases 28 through the flexible conduit 4. The first inner surface 18 of the inlet pipe 10 that tapers or slopes between the first diameter 16 and the smaller second diameter 20 in this case is a smooth conical shape. The first inner surface 18 may be shaped in different ways between the first diameter 16 and the smaller second diameter 20, such as by changing the angle of the slope, or having step changes between one slope and the next. The inlet pipe 10 with the first inner surface 18 that tapers between the first diameter 16 and the smaller second diameter 20 having the converging effect can be formed into the desired shape. For the purposes of this disclosure, the formed inlet pipe 10 with the tapered first inner surface 18 may be defined as a ‘first tapered member’. Other processes such as manufacturing a separate first tapered part with a first diameter 16 and a smaller second diameter 20, which may also be defined as a ‘first tapered member’, and welding the first tapered part to the inlet pipe 10, are possible. Forming a variable cross-section inlet pipe into the desired shape allows for a cheaper and more efficient manufacturing process, than if a separate tapered part was attached to the inlet of the flexible conduit 4 or as an extension to the inlet pipe, however, a separate tapered part would allow for more flexibility with placement as demonstrated in FIG. 4. A portion, or all, of the tapered member is disposed inside the flexible conduit 4. While the addition of the plate 22 keeps the gases 28 away from the corrugations 14 and the inner surface 30 of the flexible conduit 4 effectively, a high back pressure may be caused by the smaller internal diameter hole 24 of the plate 22. It is believed that the plate 22 may be diverging the gases 28 back which would create turbulence and cause noise. This issue was unexpectedly resolved by the second embodiment described herein.

Referring now to FIG. 2, a second embodiment of a flexible conduit system, 32 is shown with the flexible conduit 4, coupled to the inlet pipe 10 on the inlet end 6 of the flexible conduit 4 and an outlet pipe 34 on the outlet end 8 of the flexible conduit 4. The inlet pipe 10 and the outlet pipe 34 may be coupled to the flexible conduit 4 by means of welding. Other means of coupling such as brazing to form a connection or more flexible means such as using a rotary or sliding attachment so that the inlet pipe 10 and outlet pipe 34 can rotate or slide with respect to the flexible conduit 4 are also possible. Similar to the inlet pipe 10, the outlet pipe 34 has a variable cross-section such that it tapers into the flexible conduit 4. The tapered portion of the outlet pipe 34 has a diverging effect on the gases 28 exiting the flexible conduit 4. The tapered portion of the outlet pipe 34 that is coupled to the flexible conduit 4 has a second inner surface 38 that tapers or slopes down beyond the point of coupling into the flexible conduit 4, starting with a third diameter 36 and ending with a fourth diameter 40 that is smaller than the third diameter 36. The length of the second inner surface 38 and the smaller fourth diameter 40 are determined based on the levels of restriction allowed for the gases 28 determined through experimentation and noise reduction required for the application. The third diameter 36 may be the same as or different than the first diameter 16 and the fourth diameter 40 may be the same as or different than second diameter 20. In this case the tapered second inner surface 38 is smooth with a consistent angle between the third diameter 36 and the smaller fourth diameter 40; however other structural variances are possible, such as a taper with a step between two different slopes, or a variable angle of the slope, for example. When the gases 28 flow through the flexible conduit 4, the diverging effect of the outlet pipe 32 enables the centering of the gases 28 keeping them away from the corrugations 14 and the inner surface 30 of the flexible conduit 4. When the gases 28 are kept away from the corrugations 14, noise is reduced. Compared to the previous embodiment, the diverging effect of the outlet pipe 34 has the unexpected advantage of reducing back pressure that results from the gases 28 exiting through a smaller diameter than the diameter of the flexible conduit 4 as compared to first embodiment. Having the inlet pipe 10 and the outlet pipe 34 tapering into the flexible conduit 4 additionally reduces the distance that the gases 28 have to travel in the flexible conduit 4. The reduced distance between the inlet pipe 10 and the outlet pipe 34 is advantageous in that the gases 28 spend less time in the flexible conduit 4 and can be controlled better from the inlet end 6 of the flexible conduit 4 to the outlet end 8 of the flexible conduit 4 thereby reducing the levels of noise produced and the length of time that noise may be produced. Since a liner is not needed to resolve the issue of noise, the flexible conduit 4 can be more flexible and can respond better to any relative motion between the inlet end 6 and the outlet end 8. The inlet pipe 10 may be defined as a ‘first tapered member’ and the outlet pipe 34 may be defined as a ‘second tapered member’ for the purposes of this application. It is possible to manufacture a separate tapered part independent of the inlet pipe 10, also defined as a ‘first tapered member’ for the purposes of this application, with the converging effect and a separate tapered part independent of the outlet pipe 34, also defined as a ‘second tapered member’ for the purposes of this application, with the diverging effect that can be variably fixed along the length of the flexible conduit 4 as shown in FIG. 4. However, it is relatively more cost efficient and easier to form one piece inlet and outlet pipes with tapered portions.

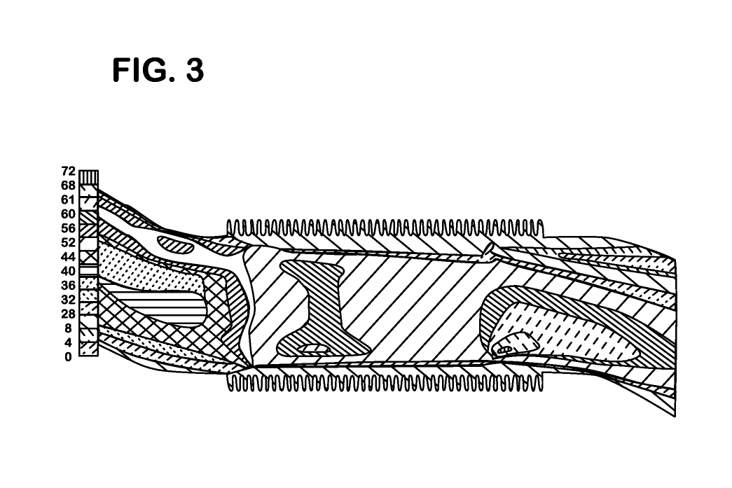

Referring now to FIG. 3, the results of a simulation generated using the second embodiment are shown. The simulation shows the effect of having a converging type first tapered member on the inlet end 6 of the flexible conduit 4 and a diverging type second tapered member on the outlet end 8 of the flexible conduit 4 on the velocity of the gases 28 as they flow through the flexible conduit 4. As can be seen, the velocity of the gases 28 is reduced near the corrugations 14 of the flexible conduit 4, and is higher away from the corrugations 14 of the flexible conduit 4. The lower velocity of the gases 28 by the corrugations 14 reduces noise and whistling within the flexible conduit 4.

FIG. 4 demonstrates another embodiment of a flexible conduit system, 42. It shows the flexible conduit 4 coupled to the inlet pipe 44 on the inlet end 6 of the flexible conduit 4 and an outlet pipe 46 on the outlet end 8 of the flexible conduit 4. The inlet pipe 44 and the outlet pipe 46 may be coupled to the flexible conduit 4 by means of welding. Other means of coupling such as brazing or more flexible means such as using a rotary or sliding attachment so that the pipes can rotate or slide with respect to the conduit are also possible. Downstream of the inlet pipe 44 is a first tapered part 48 having a first inner surface 54 that tapers from a first diameter 52 to a second diameter 56 that is smaller than the first diameter 52. The first tapered part 48 may be fixed to the flexible conduit 4 by means of welding or brazing or any other appropriate process. Further downstream in the flexible conduit 4 and upstream of the outlet pipe 46, is a second tapered part 50 with a second inner surface 60 that tapers between a third diameter 58 and a fourth diameter 62 that is smaller than the third diameter 58. The lengths of the first inner surface 54 of the first tapered part 48 and the second inner surface 60 of the second tapered part 50 and the second diameter 56 and fourth diameter 62 are determined based on the allowed levels of restriction of the gases 28 based on experimentation and noise reduction required for the application. The first tapered part 48 and the second tapered part 50 may be of similar or different diameters. When the gases 28 flow through the flexible conduit 4, the first tapered part 48 has a converging effect that centers the gases 28 keeping them away from the corrugations 14 and inner surface 30 of the flexible conduit 4. The second tapered part 50 has a diverging effect that directs or channels the gases 28 away from the corrugations 14 of the flexible conduit 4. When the gases 28 are kept away from the corrugations 14 and the inner surface 30 of the flexible conduit 4, noise is reduced. Based on the noise and restriction requirements, the first tapered part 48 and the second tapered part 50 may offer more flexibility with placement in an application independent of the inlet and outlet pipe being used. For the purposes of this application, the first tapered part 48 is defined by a ‘first tapered member’ and the second tapered part 50 is defined by a ‘second tapered member’.

What is claimed is:

1. A flexible conduit system, comprising:
a flexible conduit with an inlet end and an outlet end;
a first tapered member having a first inner surface with a first diameter and a second diameter;
a second tapered member having a second inner surface with a third diameter and a fourth diameter;
wherein the first diameter and the second diameter are different;
wherein the third diameter and the fourth diameter are different; and
wherein both the first tapered member and the second tapered member are disposed within the flexible conduit.

2. The flexible conduit system of claim 1, wherein the conduit has a plurality of corrugations to accommodate flexing of the flexible conduit

3. The flexible conduit system of claim 1 wherein the first tapered member is upstream of the second tapered member

4. The flexible conduit system of claim 1 wherein the first diameter of the first tapered member is coupled to the inlet end of the flexible conduit

5. The flexible conduit system of claim 1 wherein the third diameter of the second tapered member is coupled to the outlet end of the flexible conduit

6. The flexible conduit system of claim 1 wherein the first tapered member is placed towards the inlet end of the flexible conduit

7. The flexible conduit system of claim 1 wherein the second tapered member is placed towards the outlet end of the flexible conduit

8. The flexible conduit system of claim 1 wherein the first tapered member is a formed inlet pipe

9. The flexible conduit system of claim 1 wherein the second tapered member is a formed outlet pipe

10. The flexible conduit system of claim 1 wherein the second diameter of the tapered member is smaller than the first diameter of the inlet pipe

11. The flexible conduit system of claim 1 wherein the fourth diameter of the tapered member is smaller than the third diameter of the outlet pipe

12. The flexible conduit system of claim 1 wherein the first tapered member and the second tapered member are at least partially inside the flexible conduit

13. The flexible conduit system of claim 1 wherein both the inlet pipe and the outlet pipe are coupled to the flexible conduit by means of welding.

14. The flexible conduit system of claim 1 wherein the first tapered member and the second tapered member each have a smooth internal surface

15. A flexible conduit system connected to an inlet pipe and an outlet pipe, comprising:
a flexible conduit with corrugations and an inlet end and an outlet end;
a first tapered member with an inner surface having a first diameter and a second diameter;
a second tapered member with an inner surface having a third diameter and a fourth diameter;
wherein the flexible conduit with corrugations allows for movement between the inlet pipe and the outlet pipe;
wherein the first diameter and the second diameter different and the third diameter and fourth diameter differ;
wherein the first tapered member centers the flow of gases away from the corrugations through the inlet end of the flexible conduit with corrugations;
wherein the second tapered member channels the flow of gases away from the corrugations through the outlet end of the flexible conduit with corrugations; and wherein keeping flow of gases away from the corrugations results in a reduction in noise in the flexible conduit.
